(19) United States
(12) Patent Application Publication
(10) Pub. No.: US 2022/0074318 A1
(43) Pub. Date: Mar. 10, 2022

(54) TURBOCHARGER BUSHING AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Ryoji SHIGETA, Sagamihara-shi (JP); Sho IMAGAMA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 17/420,803

(22) PCT Filed: Jan. 23, 2019
(86) PCT No.: PCT/JP2019/001990

§ 371 Date: Jul. 6, 2021

(51) Int. Cl. F01D 25/16

(52) U.S. Cl. CPC F01D 25/166; F05D 2220/40

(57) ABSTRACT

A turbocharger bushing of cylindrical shape has at least one recess formed on an inner peripheral surface of the bushing at a position away from at least one end of both ends of the bushing.

### TECHNICAL FIELD

The present disclosure relates to a turbocharger bushing and a turbocharger.

### BACKGROUND

Patent Document 1 discloses a bushing which supports a shaft part of an open/close lever connected to a waste-gate valve of a turbocharger while allowing the shaft part to rotate. The bushing has a groove formed from one end to the other end of the bushing in the axial direction to collect particles that cause adhesion between the shaft part and the bushing.

### CITATION LIST

### Patent Literature

Patent Document 1: U.S. Pat. No. 9,546,597B

### SUMMARY

### Problems to be Solved

As described above, since the groove formed in the bushing disclosed in Patent Document 1 extends from one end to the other end of the bushing, exhaust gas flowing inside the turbocharger is likely to flow out of the turbocharger through the groove.

In view of the above, an object of at least one embodiment of the present invention is to provide a turbocharger bushing and a turbocharger whereby it is possible to suppress the outflow of exhaust gas while suppressing adhesion between the bushing and the shaft part.

### Solution to the Problems

(1) A turbocharger bushing according to at least one embodiment of the present invention is of cylindrical shape, with at least one recess formed on an inner peripheral surface of the bushing at a position away from at least one end of both ends of the bushing.

With the turbocharger bushing described in the above (1), particles that cause adhesion between the bushing and the shaft part are collected in the recess, so that adhesion between the bushing and the shaft part can be suppressed. Herein, the term “particles” includes, for example, abrasion powder produced by friction between the bushing and the shaft part, and salt crystals produced by evaporation of salt water that has entered a space between the bushing and the shaft part from outside the turbocharger.

Further, since particles that cause adhesion between the bushing and the shaft part tend to collect in the recess on the inner peripheral surface of the bushing due to the centrifugal force caused by rotation of the shaft part, adhesion between the bushing and the shaft part can be suppressed effectively, compared to the case where the recess is formed on the outer peripheral surface of the shaft part.

In addition, since the recess is formed away from at least one of the two ends of the bushing, exhaust gas flowing inside the turbocharger casing can be prevented from flowing out through a space between the bushing and the shaft part, compared to the case where the groove is formed from one end to the other end of the bushing, as in the configuration of Patent Document 1.

(2) In some embodiments, in the turbocharger bushing described in the above (1), the at least one recess includes a recess formed at a position away from both ends of the bushing.

With the turbocharger bushing described in the above (2), since the recess is formed away from both ends of the bushing, exhaust gas flowing inside the turbocharger casing can be effectively prevented from flowing out through a space between the bushing and the shaft part.

(3) In some embodiments, in the turbocharger bushing described in the above (1), the at least one recess includes a recess connecting to the other end of both ends of the bushing.

With the turbocharger bushing described in the above (3), exhaust gas flowing inside the turbocharger casing can be prevented from flowing out through a space between the bushing and the shaft part while removing particles collected in the recess from the other end of the bushing.

(4) In some embodiments, in the turbocharger bushing described in any one of the above (1) to (3), the at least one recess includes a recess with a central position that is offset from a central position of the bushing in an axial direction of the bushing.

With the turbocharger bushing described in the above (4), since the bushing can be arranged so that the center of the recess is closer to the outside of the casing than the central position of the bushing is, particles accumulated in the recess can be effectively discharged to the outside of the casing by the pressure difference between the inside and outside of the casing.

(5) In some embodiments, in the turbocharger bushing described in the above (4), the at least one recess includes a recess group composed of a plurality of recesses, and a central position of the recess group is offset from the central position of the bushing in the axial direction of the bushing.

With the turbocharger bushing described in the above (5), since the bushing can be arranged so that the central position of the recess group is closer to the outside of the casing than the central position of the bushing is, particles accumulated in the recess group can be effectively discharged to the outside of the casing by the pressure difference between the inside and outside of the casing.

(6) In some embodiments, in the turbocharger bushing described in any one of the above (1) to (5), the at least one recess includes at least one circumferential recess extending along a circumferential direction of the bushing.

With the turbocharger bushing described in the above (6), exhaust gas flowing inside the turbocharger casing can be effectively prevented from flowing out through a space between the bushing and the shaft part, compared to the case where the recess extends along the axial direction.

(7) In some embodiments, in the turbocharger bushing described in the above (6), the at least one circumferential recess includes a recess formed in an annular shape.

With the turbocharger bushing described in the above (7), exhaust gas flowing inside the turbocharger casing can be effectively prevented from flowing out through a space between the bushing and the shaft part, compared to the case where the recess extends along the axial direction.

(8) In some embodiments, in the turbocharger bushing described in the above (6) or (7), the at least one circumferential recess includes a plurality of circumferential recesses arranged at intervals in an axial direction of the bushing.

With the turbocharger bushing described in the above (8), since the plurality of circumferential recesses forms a labyrinth structure between the bushing and the shaft part, exhaust gas flowing inside the turbocharger casing can be effectively prevented from flowing out through a space between the bushing and the shaft part.

(9) In some embodiments, in the turbocharger bushing described in any one of the above (1) to (5), the at least one recess includes at least one axial recess extending along an axial direction of the bushing.

With the turbocharger bushing described in the above (9), when the shaft part rotates, particles that cause adhesion on the outer peripheral surface of the shaft part can be scraped into the axial recess. Accordingly, it is possible to effectively suppress adhesion between the bushing and the shaft part.

(10) In some embodiments, in the turbocharger bushing described in the above (9), the at least one axial recess includes a plurality of axial recesses arranged at intervals in a circumferential direction of the bushing.

With the turbocharger bushing described in the above (10), when the shaft part rotates, particles that cause adhesion on the outer peripheral surface of the shaft part can be scraped into the plurality of axial recesses. Accordingly, it is possible to effectively suppress adhesion between the bushing and the shaft part.

(11) In some embodiments, in the turbocharger bushing described in any one of the above (1) to (5), the at least one recess includes a spiral recess formed in a spiral around an axis of the bushing.

With the turbocharger bushing described in the above (11), the spiral recess provides both the exhaust gas outflow suppression effect of the labyrinth structure and the adhesion suppression effect between the bushing and the shaft part by scraping in particles.

(12) In some embodiments, in the turbocharger bushing described in any one of the above (1) to (5), the at least one recess includes a plurality of recesses that are offset from each other in each of an axial direction of the bushing and a circumferential direction of the bushing.

With the turbocharger bushing described in the above (12), since the recesses are offset from each other in each of the axial direction and the circumferential direction, exhaust gas flowing inside the turbocharger casing can be effectively prevented from flowing out through a space between the bushing and the shaft part, and particles that cause adhesion on the outer peripheral surface of the shaft part can be scraped into the recesses to effectively suppress adhesion between the bushing and the shaft part.

(13) A turbocharger according to at least one embodiment of the present invention comprises: a casing having a flow passage for an exhaust gas formed inside the casing; a shaft part extending from inside to outside of the casing; and a bushing fixed to the casing and supporting the shaft part while allowing the shaft part to rotate. The bushing is the bushing described in any one of the above (1) to (12).

With the turbocharger described in the above (13), since the bushing described in any one of the above (1) to (12) is included, it is possible to suppress the outflow of exhaust gas while suppressing adhesion between the bushing and the shaft part.

(14) In some embodiments, in the turbocharger described in the above (13), the at least one recess includes a recess with a central position that is closer to the outside of the casing than a central position of the bushing is in an axial direction of the bushing.

With the turbocharger described in the above (14), since the inner peripheral surface of the bushing has the recess with the central position that is closer to the outside of the casing than the central position of the bushing is, particles accumulated in the recess can be easily discharged to the outside of the casing.

(15) In some embodiments, in the turbocharger described in the above (14), the at least one recess includes a recess group composed of a plurality of recesses, and a central position of the recess group is closer to the outside of the casing than the central position of the bushing is in the axial direction of the bushing.

With the turbocharger described in the above (15), since the central position of the recess group is closer to the outside of the casing than the central position of the bushing is, particles accumulated in the recess group can be easily discharged to the outside of the casing.

### Advantageous Effects

At least one embodiment of the present invention provides a turbocharger bushing and a turbocharger whereby it is possible to suppress the outflow of exhaust gas while suppressing adhesion between the bushing and the shaft part.

### BRIEF DESCRIPTION OF DRAWINGS

FIG. 1 is a schematic block diagram showing a configuration of a turbocharger 100 according to an embodiment.

FIG. 2 is a vertical cross-sectional view of a driving part of a waste-gate valve 8 shown in FIG. 1.

FIG. 3 is a cross-sectional view taken along line A-A in FIG. 2.

FIG. 4 is a schematic cross-sectional view of a bushing 18 according to an embodiment, taken along the axial direction.

FIG. 5 is a schematic cross-sectional view of a bushing 18 according to another embodiment, taken along the axial direction.

FIG. 6 is a schematic cross-sectional view of a bushing 18 according to another embodiment, taken along the axial direction.

FIG. 7 is a schematic cross-sectional view of a bushing 18 according to another embodiment, taken along the axial direction.

FIG. 8 is a schematic cross-sectional view of a bushing 18 according to another embodiment, taken along the axial direction.

FIG. 9 is a schematic cross-sectional view of a bushing 18 according to another embodiment, taken along the axial direction.

FIG. 10 is a schematic cross-sectional view of a bushing 18 according to another embodiment, taken along the axial direction.

FIG. 11 is a schematic cross-sectional view of a bushing 18 according to another embodiment, taken along the axial direction.

FIG. 12 is a schematic cross-sectional view of a bushing 18 according to another embodiment, taken along the axial direction.

FIG. 13 is a cross-sectional view showing a partial configuration of a turbocharger 200 according to an embodiment.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

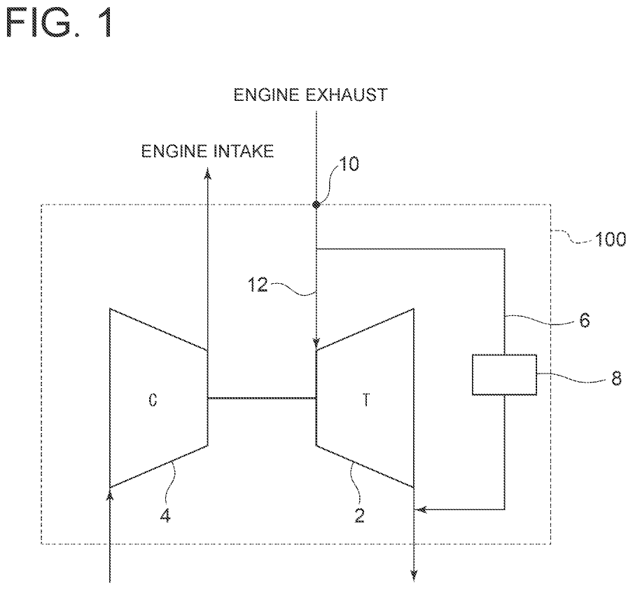

FIG. 1 is a schematic block diagram showing a configuration of a turbocharger 100 according to an embodiment. As shown in FIG. 1, the turbocharger 100 includes a turbine 2 configured to be rotated by exhaust gas of an engine (not shown), a compressor 4 configured to be driven by the turbine 2 to compress intake air of the engine, and a waste-gate valve 8 for opening and closing a bypass passage 6 bypassing the turbine 2.

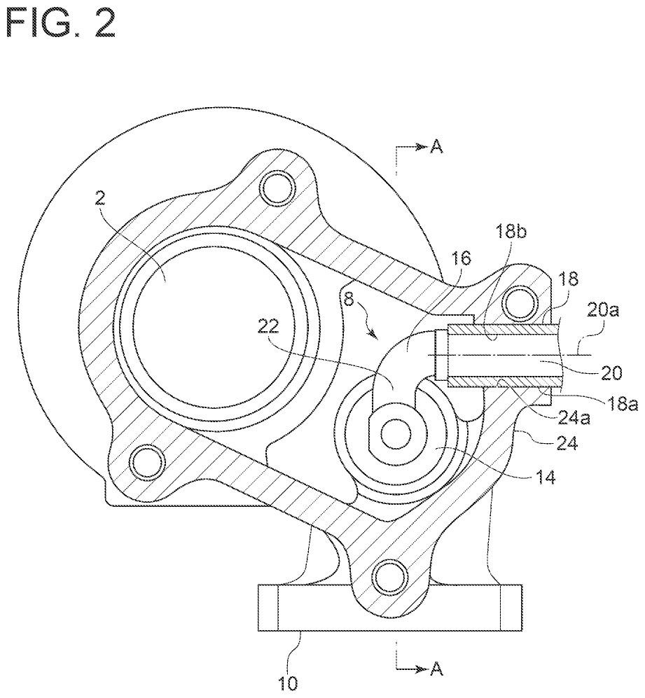

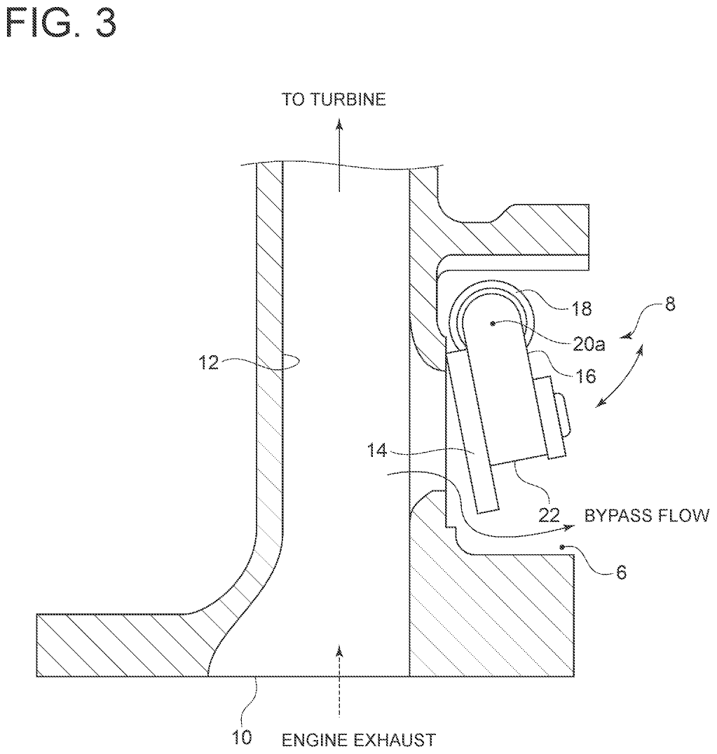

FIG. 2 is a vertical cross-sectional view of a driving part of the waste-gate valve 8 shown in FIG. 1. FIG. 3 is a cross-sectional view taken along line A-A in FIG. 2.

As shown in at least one of FIGS. 1 and 3, the bypass passage 6 branches off from an exhaust gas passage 12 connecting an exhaust inlet 10 of the turbocharger 100 with the turbine 2, and is configured such that exhaust gas diverted from the exhaust gas passage 12 bypasses the turbine and is guided to the downstream side of the turbine 2. The bypass passage 6 is formed in a casing 24 of the turbocharger 100.

As shown in at least one of FIGS. 2 and 3, the waste-gate valve 8 includes a valve body 14 disposed in the bypass passage 6, an open/close lever 16 connected to the valve body 14 and configured to move the valve body 14 to open or close the bypass passage 6, and a bushing 18. In the illustrated embodiments, the open/close lever 16 is formed in an L-shape, and is configured such that as a shaft part 20 on the base side rotates around an axis 20a, an operation part 22 (connected to the valve body 14) on the tip side rotates the valve body 14 around the axis 20a to open or close the bypass passage 6.

As shown in FIG. 2, the bushing 18 is formed in a cylindrical shape. The bushing 18 is fixed to the casing 24 by fitting an outer peripheral surface 18a of the bushing 18 into a through hole 24a of the casing 24. In the illustrated embodiment, the bushing 18 extends from inside to outside of the casing 24 so as to penetrate the casing 24.

The shaft part 20 extends from inside to outside of the casing 24 so as to penetrate the casing 24. The shaft part 20 is inserted in the bushing 18, and an inner peripheral surface 18b of the bushing 18 is configured to support the shaft part 20 of the open/close lever 16 while allowing the shaft part 20 to rotate.

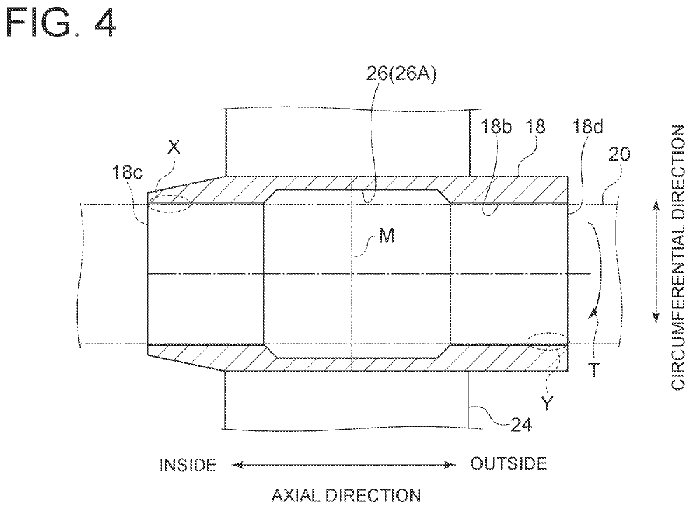

Next, with reference to FIGS. 4 to 12, configuration examples of the bushing 18 according to some embodiments will be described. The embodiments shown in FIGS. 4 to 12 are different in the shape of the inner peripheral surface 18b of the bushing 18. Hereinafter, the axial direction of the bushing 18 is simply referred to as “axial direction”, and the circumferential direction of the bushing 18 is simply referred to as “circumferential direction”.

In some embodiments, for example as shown in FIGS. 4 to 12, at least one recess 26 is formed on the inner peripheral surface 18b of the bushing 18 at a position away from at least one end (18c and/or 18d) of both ends 18c, 18d of the bushing 18.

With this configuration, particles that cause adhesion between the bushing 18 and the shaft part 20 are collected in the recess 26, so that adhesion between the bushing 18 and the shaft part 20 can be suppressed. Herein, the term “particles” includes, for example, abrasion powder produced by friction between the bushing 18 and the shaft part 20, salt crystals produced by evaporation of salt water that has entered a space between the bushing 18 and the shaft part 20 from outside the turbocharger 100, other particles, and combination of these particles.

In particular, since hot exhaust gas flows inside the casing 24, no lubricant is used between the bushing 18 and the shaft part 20, and the abrasion powder is likely to be produced. Therefore, by trapping the abrasion powder in the recess 26 to hold the abrasion powder, it is possible to effectively suppress adhesion between the bushing 18 and the shaft part 20. If the turbocharger is an automotive turbocharger, adhesion between the bushing and the shaft part is likely to occur particularly by the salt crystals, but the turbocharger 100 can effectively suppress adhesion between the bushing and the shaft part caused by the salt crystals.

Further, since particles that cause adhesion between the bushing 18 and the shaft part 20 tend to collect in the recess 26 on the inner peripheral surface 18b of the bushing 18 due to the centrifugal force caused by rotation of the shaft part 20, adhesion between the bushing 18 and the shaft part 20 can be suppressed effectively, compared to the case where the recess is formed on the outer peripheral surface of the shaft part 20.

In addition, since the recess 26 is formed away from at least one of the two ends 18c, 18d of the bushing 18, exhaust gas flowing inside the casing 24 of the turbocharger 100 can be prevented from flowing out through a space between the bushing 18 and the shaft part 20, compared to the case where the groove is formed from one end to the other end of the bushing 18, as in the configuration of Patent Document 1.

In some embodiments, for example in the configurations shown in FIGS. 4 to 12, the hardness of the bushing 18 is higher than the hardness of the shaft part 20. In this case, the materials of the bushing 18 and the shaft part 20 are not limited. For example, the material of the bushing 18 may be sintered austenitic stainless steel, and the material of the shaft part 20 may be heat-resistant cast steel such as SCH21.

As described above, when the hardness of the bushing 18 is higher than the hardness of the shaft part 20, abrasion of the inner peripheral surface 18b of the bushing 18 due to friction between the bushing 18 and the shaft part 20 may be suppressed, compared to the case where the hardness of the shaft part 20 is higher than the hardness of the bushing 18.

In this case, the effect of collecting particles that cause adhesion between the bushing 18 and the shaft part 20 in the recess 26, which prevents the recess 26 on the inner peripheral surface 18b of the bushing 18 from deforming and becoming shallower due to abrasion, can be maintained over a long period of time.

In some embodiments, for example as shown in FIGS. 4 to 8 and 10 to 12, the at least one recess 26 on the inner peripheral surface 18b of the bushing 18 includes a recess 26 formed at a position away from both ends 18c, 18d of the bushing 18.

With this configuration, since the recess 26 is formed away from both ends 18c, 18d of the bushing 18, exhaust gas flowing inside the casing 24 of the turbocharger 100 can be effectively prevented from flowing out through a space between the bushing 18 and the shaft part 20.

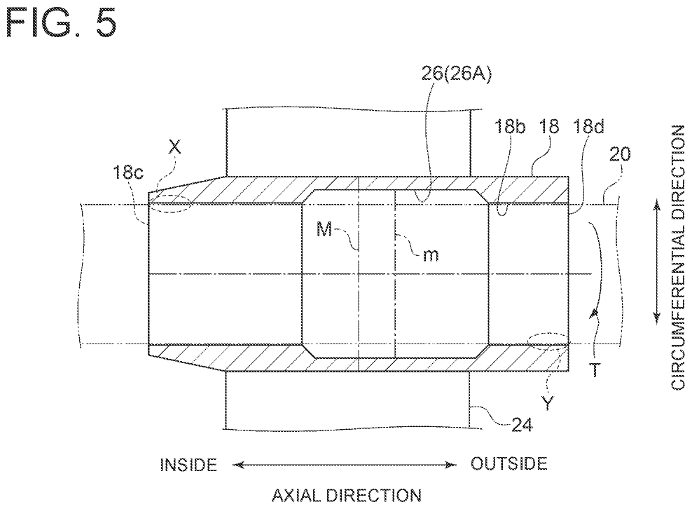

Further, for example as shown in FIGS. 4 and 5, since the main areas X and Y where the bushing 18 receives torque T from the shaft part 20 are both ends of the bushing 18, when the recess 26 is formed away from both ends 18c, 18d, the aforementioned effect of the recess 26 can be achieved while securing the area of the inner peripheral surface 18b of the bushing 18 that contributes to supporting the shaft part 20.

Further, according to the knowledge of the inventors, the abrasion powder tends to accumulate in the vicinity of the central position M of the bushing 18 in the axial direction. Therefore, when the recess 26 is formed away from both ends 18c, 18d of the bushing 18, the abrasion powder can be effectively trapped in the recess 26. In particular, when the recess 26 is formed in a range including the central position M in the axial direction, it is possible to effectively suppress adhesion between the bushing 18 and the shaft part 20 due to the abrasion powder.

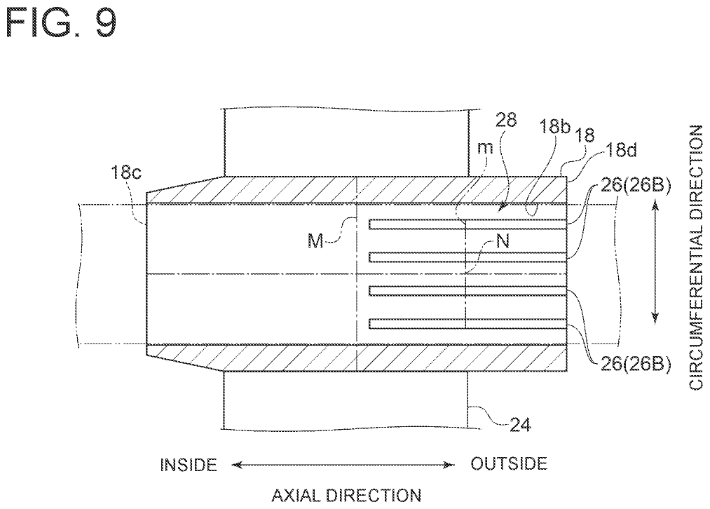

In some embodiments, for example as shown in FIG. 9, the at least one recess 26 on the inner peripheral surface 18b of the bushing 18 includes a recess 26 away from one end 18c and contiguous to the other end 18d of both ends 18c, 18d of the bushing 18. In the exemplary embodiment shown in FIG. 9, the recess 26 connects to the end 18d, of the two ends 18c, 18d of the bushing 18, disposed outside the casing 24.

With this configuration, exhaust gas flowing inside the casing 24 of the turbocharger 100 can be prevented from flowing out through a space between the bushing 18 and the shaft part 20 while removing particles collected in the recess 26 from the other end of the bushing 18.

In some embodiments, for example as shown in FIGS. 5, 7, 9, and 12, the at least one recess 26 on the inner peripheral surface 18b of the bushing 18 includes a recess 26 with the central position m that is offset from the central position M of the bushing 18 in the axial direction. In the illustrated embodiment, the at least one recess 26 includes a recess 26 with the central position m that is closer to the outside of the casing 24 than the central position M of the bushing 18 is in the axial direction.

Since the pressure inside the casing 24 of the turbocharger 100 is higher than the pressure outside the casing 24, when the central position m of the recess 26 is closer to the outside of the casing 24 than the central position M of the bushing 18 is, particles accumulated in the recess 26 can be effectively discharged to the outside of the casing 24 by the pressure difference between the inside and outside of the casing 24.

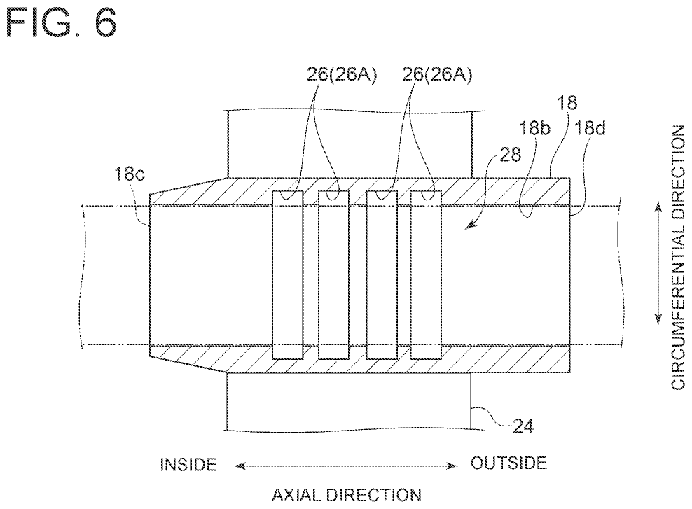

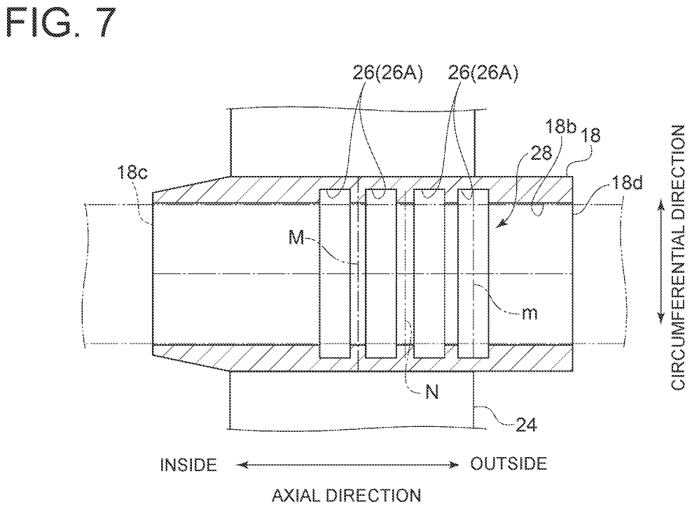

In some embodiments, for example as shown in FIGS. 6 to 10, the at least one recess 26 on the inner peripheral surface 18b of the bushing 18 includes a recess group 28 composed of a plurality of recesses 26. In the embodiments shown in FIGS. 7 and 9, in the axial direction, the central position N of the recess group 28 is offset from the central position M of the bushing 18, and is closer to the outside of the casing 24 than the central position M of the bushing 18 is.

As described above, when the bushing 18 is arranged so that the central position N of the recess group 28 is closer to the outside of the casing 24 than the central position M of the bushing 18 is, particles accumulated in the recess group 28 can be effectively discharged to the outside of the casing 24 by the pressure difference between the inside and outside of the casing 24. In other embodiments, in the axial direction, the central position N of the recess group 28 may be closer to the inside of the casing 24 than the central position M of the bushing 18 is.

In some embodiments, for example as shown in FIGS. 4 to 7, the at least one recess 26 on the inner peripheral surface 18b of the bushing 18 includes at least one circumferential recess 26A (circumferential groove) extending along the circumferential direction. In the illustrated embodiments, each circumferential recess 26A is formed in an annular shape.

With this configuration, exhaust gas flowing inside the casing 24 of the turbocharger 100 can be effectively prevented from flowing out through a space between the bushing 18 and the shaft part 20, compared to the case where the recess 26 extends along the axial direction.

In some embodiments, for example as shown in FIGS. 6 and 7, the at least one circumferential recess 26A on the inner peripheral surface 18b of the bushing 18 includes a plurality of circumferential recesses 26A arranged at intervals in the axial direction.

With this configuration, since the plurality of circumferential recesses 26A forms a labyrinth structure between the bushing 18 and the shaft part 20, exhaust gas flowing inside the casing 24 of the turbocharger 100 can be effectively prevented from flowing out through a space between the bushing 18 and the shaft part 20.

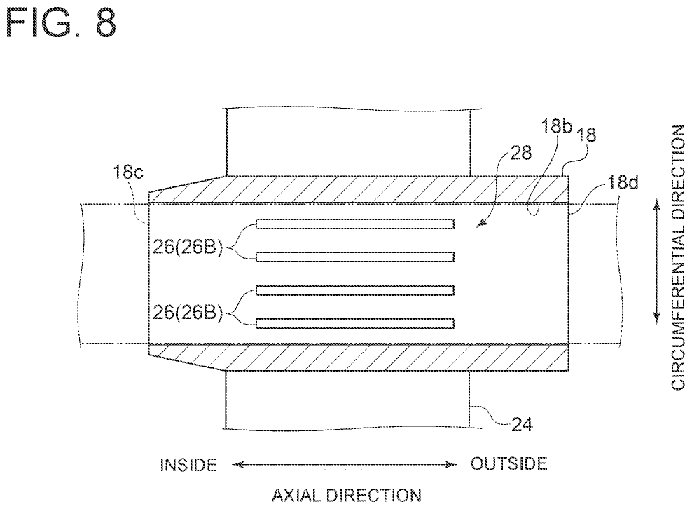

In some embodiments, for example as shown in FIGS. 8 to 10, the at least one recess 26 on the inner peripheral surface 18b of the bushing 18 includes at least one axial recess 26B (axial groove) extending along the axial direction. In the illustrated embodiments, the at least one axial recess 26B includes a plurality of axial recesses 26B arranged at intervals in the circumferential direction.

With this configuration, when the shaft part 20 rotates, particles that cause adhesion on the outer peripheral surface of the shaft part 20 can be scraped into the axial recess 26. Accordingly, it is possible to effectively suppress adhesion between the bushing 18 and the shaft part 20.

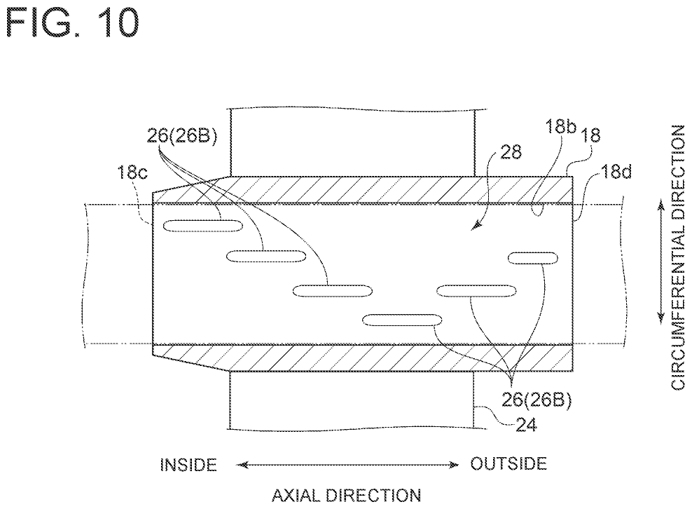

In some embodiments, for example as shown in FIG. 10, the at least one recess 26 on the inner peripheral surface 18b of the bushing 18 includes a plurality of recesses 26 that are offset from each other in each of the axial direction and the circumferential direction.

With this configuration, since the recesses 26 are offset from each other in each of the axial direction and the circumferential direction, exhaust gas flowing inside the casing 24 of the turbocharger 100 can be effectively prevented from flowing out through a space between the bushing 18 and the shaft part 20, and particles that cause adhesion on the outer peripheral surface of the shaft part 20 can be scraped into the recesses 26 to effectively suppress adhesion between the bushing 18 and the shaft part 20.

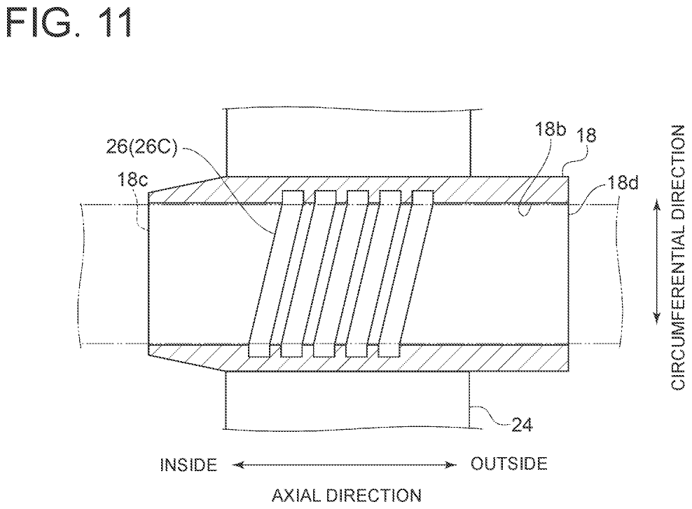

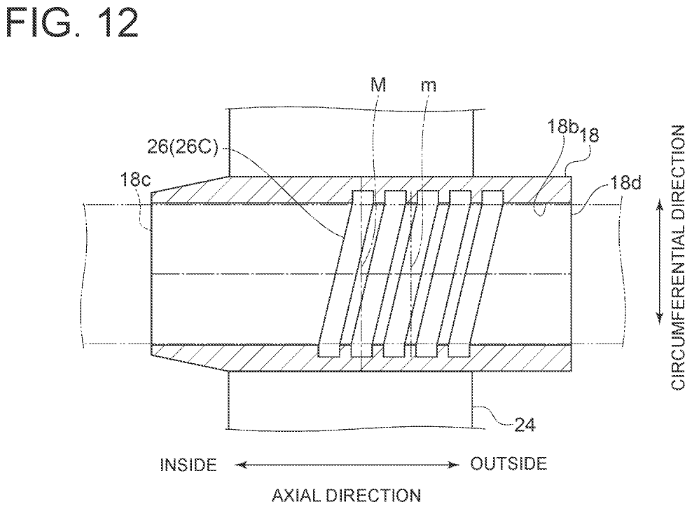

In some embodiments, for example as shown in FIGS. 11 and 12, the at least one recess 26 on the inner peripheral surface 18b of the bushing 18 includes a spiral recess 26C (spiral groove) formed in a spiral around the axis of the bushing 18.

With this configuration, the spiral recess 26 provides both the exhaust gas outflow suppression effect of the labyrinth structure and the adhesion suppression effect between the bushing 18 and the shaft part 20 by scraping in particles.

The present invention is not limited to the embodiments described above, but includes modifications to the embodiments described above, and embodiments composed of combinations of those embodiments.

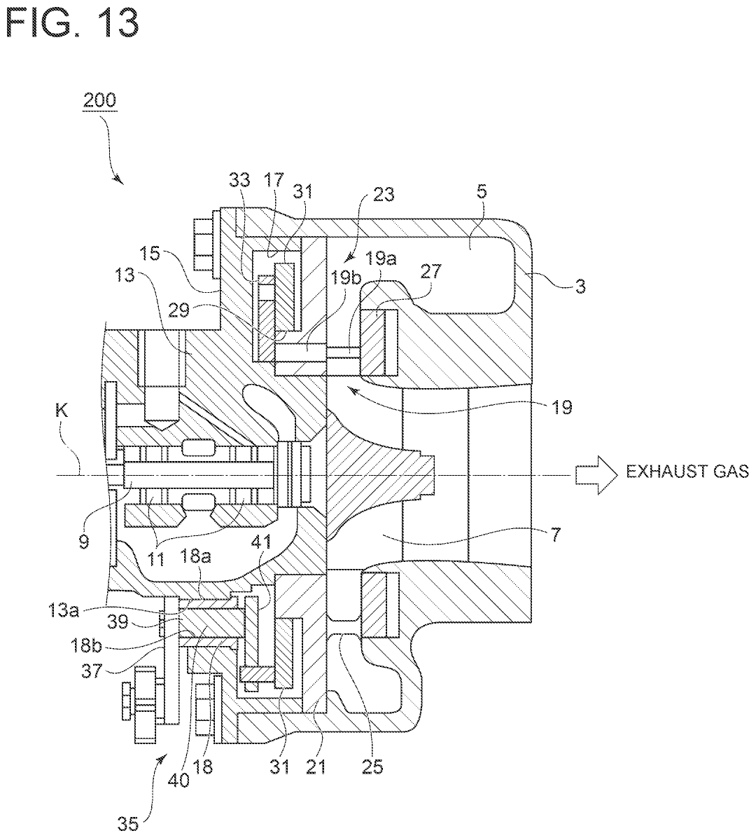

For example, in the above-described embodiments, the bushing 18 for rotatably supporting the shaft part 20 of the open/close lever 16 of the waste-gate valve 8 has been described. However, the bushing 18 shown in FIGS. 4 to 12 may be applied to a bushing 18 for rotatably supporting a control crank 39 of a variable geometry turbocharger 200 for example as shown in FIG. 13, as described below.

FIG. 13 is a schematic cross-sectional view of a variable geometry turbocharger 200 according to an embodiment of the present invention, taken along the rotational axis of the turbocharger 200.

As shown in FIG. 13, the turbocharger 200 is provided with a cylindrical turbine casing 3, and the turbine casing 3 has a scroll 5 formed in a spiral. In the turbine casing 3, a turbine rotor 7 is disposed.

A turbine shaft 9, on which the turbine rotor 7 is mounted, is coaxial with a compressor, which is not shown. The turbine shaft 9 is rotatably supported by a bearing casing 13 via a bearing 11.

A variable nozzle mechanism 23, which is a nozzle assembly including nozzles 19 and a nozzle mount 21, is mounted on the side of the bearing casing 13 adjacent to the scroll 5. The nozzles 19 are arranged at intervals around the rotational axis K of the turbine shaft 9. The nozzles 19 are disposed inward of the scroll 5 in the radial direction of the turbine.

Each nozzle 19 has a nozzle vane 19a and a nozzle shaft 19b. The nozzle shafts 19b are rotatably supported by the nozzle mount 21 fixed to the bearing casing 13. Support parts of the nozzle shafts 19b are arranged at equal intervals around the rotational axis K. By this variable nozzle mechanism 23, the blade angles of the nozzle vanes 19a can be changed.

The nozzle vanes 19a are disposed between the nozzle mount 21 and an annular nozzle plate 27 connected to the nozzle mount 21 so as to face the nozzle mount 21 with a predetermined distance by a nozzle support 25 in the turbine axial direction. The nozzle plate 27 is fitted to the tip side of the inner cylinder of the turbine casing 3.

The nozzle mount 21 has a step 29 in the radial direction, and a disk-shaped drive ring 31 is fitted in the step 29 rotatably and concentrically with the rotational axis K. The drive ring 31 is engaged with a plurality of lever plates 33 arranged in the circumferential direction. One end of the lever plate 33 is attached to the drive ring 31, and the other end is connected to the end of the nozzle shaft 19b which passes through the inside of the nozzle mount 21 in the same direction as the rotational axis K.

The nozzle shaft 19b and nozzle vane 19a are rotated according to the angle at which the drive ring 31 is rotated around the rotational axis K. In other words, the degree of opening of the nozzle 19 can be adjusted by rotating the drive ring 31.

The variable nozzle mechanism 23 is an assembly including the nozzles 19 (19a, 19b), the nozzle mount 21, the nozzle plate 27, the drive ring 31, and the lever plates 33. Further, an annular storage part 17 is formed in a back part 15 of the bearing casing 13. In the storage part 17, a linkage mechanism 35 penetrating the back part 15 is disposed.

The linkage mechanism 35 includes an input lever 37 connected at one end to an actuator (not shown) for actuating the variable nozzle mechanism 23, a control crank 39 connected to the other end of the input lever 37 and disposed through the bearing casing 13, and an output lever 41 connected at one end to the control crank 39. The linkage mechanism 35 is configured to convert the reciprocating motion by the actuator into rotational motion through the input lever 37, the control crank 39, and the output lever 41 to transmit rotational force to the variable nozzle mechanism 23 assembled inside the bearing casing 13.

In the embodiment shown in FIG. 13, the turbocharger 200 is provided with a cylindrical bushing 18 for supporting a shaft part 40 of the control crank 39 while allowing the shaft part 40 to rotate. In the illustrated embodiment, the bushing 18 extends from inside to outside of the bearing casing 13 so as to penetrate the bearing casing 13. The bushing 18 is fixed to the bearing casing 13 by fitting an outer peripheral surface 18a of the bushing 18 into a through hole 13a of the bearing casing 13.

The shaft part 40 of the control crank 39 extends from inside to outside of the bearing casing 13 so as to penetrate the bearing casing 13. The shaft part 40 is inserted in the bushing 18, and an inner peripheral surface 18b of the bushing 18 is configured to support the shaft part 40 of the control crank 39 while allowing the shaft part 40 to rotate.

When the bushing 18 shown in FIGS. 4 to 12 is applied to the bushing 18 for rotatably supporting the shaft part 40 of the control crank 39, it is possible to suppress the outflow of exhaust gas while suppressing adhesion between the bushing 18 and the shaft part 40 of the control crank 39.

### REFERENCE SIGNS LIST

2 Turbine
3 Turbine casing
4 Compressor
5 Scroll
6 Bypass passage
7 Turbine rotor
8 Waste-gate valve
9 Turbine shaft
10 Exhaust inlet
11 Bearing
12 Exhaust gas passage
13 Bearing casing
13a Through hole
14 Valve body
15 Back part
16 Open/close lever
17 Storage part
18 Bushing
18a Outer peripheral surface
18b Inner peripheral surface
18c, 18d Both ends (One end, The other end)
19 Nozzle
19a Nozzle vane
19b Nozzle shaft
20 Shaft part
20a Axis
21 Nozzle mount
22 Operation part
23 Variable nozzle mechanism
24 Casing
24a Through hole
25 Nozzle support
26 Recess
26A Circumferential recess
26B Axial recess
26C Spiral recess
27 Nozzle plate
28 Recess group
29 Step
31 Drive ring
33 Lever plate
35 Linkage mechanism
37 Input lever
39 Control crank
40 Shaft part
41 Output lever
100, 200 Turbocharger

1. A turbocharger bushing of cylindrical shape,
wherein at least one recess is formed on an inner peripheral surface of the bushing at a position away from at least one end of both ends of the bushing.

2. The turbocharger bushing according to claim 1,
wherein the at least one recess includes a recess formed at a position away from both ends of the bushing.

3. The turbocharger bushing according to claim 1,
wherein the at least one recess includes a recess connecting to the other end of both ends of the bushing.

4. The turbocharger bushing according to claim 1,
wherein the at least one recess includes a recess with a central position that is offset from a central position of the bushing in an axial direction of the bushing.

5. The turbocharger bushing according to claim 4,
wherein the at least one recess includes a recess group composed of a plurality of recesses, and
wherein a central position of the recess group is offset from the central position of the bushing in the axial direction of the bushing.

6. The turbocharger bushing according to claim 1,
wherein the at least one recess includes at least one circumferential recess extending along a circumferential direction of the bushing.

7. The turbocharger bushing according to claim 6,
wherein the at least one circumferential recess includes a recess formed in an annular shape.

8. The turbocharger bushing according to claim 6,
wherein the at least one circumferential recess includes a plurality of circumferential recesses arranged at intervals in an axial direction of the bushing.

9. The turbocharger bushing according to claim 1,
wherein the at least one recess includes at least one axial recess extending along an axial direction of the bushing.

10. The turbocharger bushing according to claim 9,
wherein the at least one axial recess includes a plurality of axial recesses arranged at intervals in a circumferential direction of the bushing.

11. The turbocharger bushing according to claim 1,
wherein the at least one recess includes a spiral recess formed in a spiral around an axis of the bushing.

12. The turbocharger bushing according to claim 1,
wherein the at least one recess includes a plurality of recesses that are offset from each other in each of an axial direction of the bushing and a circumferential direction of the bushing.

13. A turbocharger, comprising:
a casing having a flow passage for an exhaust gas formed inside the casing;
a shaft part extending from inside to outside of the casing; and
a bushing fixed to the casing and supporting the shaft part while allowing the shaft part to rotate,
wherein the bushing is the bushing according to claim 1.

14. The turbocharger according to claim 13,
wherein the at least one recess includes a recess with a central position that is closer to the outside of the casing than a central position of the bushing is in an axial direction of the bushing.

15. The turbocharger according to claim 14,
wherein the at least one recess includes a recess group composed of a plurality of recesses, and
wherein a central position of the recess group is closer to the outside of the casing than the central position of the bushing is in the axial direction of the bushing.
